(19) United States
(12) Patent Application Publication
(10) Pub. No.: US 2002/0116284 A1
(43) Pub. Date: Aug. 22, 2002

(54) Method and system for operating a gaming device offering non-gaming services

(75) Inventors: Paul C. Steelman, Las Vegas, NV (US); Donald Duperault, Henderson, NV (US); Jeffrey S. Topham, (US); Heston Miles, (US); Paul K. Cernuto, (US)

Correspondence Address: JEFFER, MANGELS, BUTLER & MARMARO LLP, TENTH FLOOR, 2121 AVENUE OF THE STARS, LOS ANGELES, CA, 90067, US

(73) Assignee: Steelman Gaming Technology

(21) Appl. No.: 09/967,861

(22) Filed: Sep. 28, 2001

Related U.S. Application Data
(63) Continuation-in-part of application No. 09/678,853, filed on Oct. 4, 2000, now abandoned.

(51) Int. Cl. G06F 17/60

(52) U.S. Cl. 705/26; 705/1

(57) ABSTRACT

A method of using a gaming device, a gaming device system, and user interfaces are described. A method of operating a gaming device includes invoking one or more software modules and invoking a graphics module in communication with the one or more software modules. A screen display is then outputted as determined by the one or more software modules and as provided by the graphics module. The user interface on the gaming device offers the user the option of selecting a non-gaming function without having to leave the gaming device. Such non-gaming functions include ordering beverages, making hotel reservations, purchasing tickets, watching videos, and listening to music.

### CROSS REFERENCE TO RELATED APPLICATIONS

The present application is a continuation-in-part of application Ser. No. 09/678,853, filed Oct. 4, 2000, entitled “LCD Slot Machine Chair”. The present application is related to application Ser. No. (62853/5001), entitled “Ergonomic Gaming Machine”; application Ser. No. (62853/5002), entitled “Gaming Machine (I-Slot)”; application Ser. No. (62853/5003), entitled “Gaming Machine (Slot Lounge)”; and application Ser. No. (62853/5004), entitled “Gaming Machine (Digital-Slot)”, all of which are incorporated herein.

### BACKGROUND OF THE INVENTION

1. Field of the Invention

The present invention relates generally to gaming devices. More specifically, it relates to computer programs, hardware, and user interfaces for offering user services relating to both gaming and non-gaming functions without requiring the user to leave the gaming device.

2. Discussion of Related Art

The functionality and design of present gaming devices have not changed significantly over the years. The typical gaming device essentially allows the user to play the game or games being offered and, in addition, may allow the user to call an attendant or hostess by pressing a button on the gaming device whereby a light on top of the device is illuminated. For the vast majority of gaming devices in use the user must generally leave the device to obtain other services or to check the status of a pending activity. For example, a user is unable to check the wait list or line at a particular restaurant from the gaming device. He or she typically has to physically walk to the restaurant and leave the gaming device. In another example, a user cannot purchase tickets for an event or make hotel reservations from a gaming console or device. These and numerous other activities require that the user leave the gaming device to complete the activity. Leaving the gaming device may be undesirable to the user for a variety of reasons, such as losing the station to another user. In addition, the user is more likely to purchase tickets, order drinks, make reservations, use online data/video feed services (e.g., checking the line for a taxi or checking in on a day care center where the user's children are), if the service is easily accessible on the gaming device.

The computer software executing on most gaming devices today are not designed to handle or process any type of input other than the standard input from the user playing a particular game. The software is generally not modular and is brittle. All the graphics, logic, gaming instructions, and screen displays are “hard coded” in each device. As such, it is highly impractical and inefficient to modify these computer programs to expand into non-gaming functions or simply to modify existing gaming functions, for example, changing the denomination of a bet in the middle of playing. This is the case because most of the code for the present gaming machines was written taking a different approach to software design. Essentially, in this approach, functionality was encoded in a top-down manner to run efficiently but left little room for significant modifications, let alone paradigm shifts, such as offering non-gaming services or separating the front-end from the gaming logic.

### SUMMARY OF THE PREFERRED EMBODIMENTS

To achieve the foregoing, methods, systems and user interfaces are disclosed for operating a gaming device offering non-gaming services. In one aspect of the present invention, a method of operating a gaming device includes invoking one or more software modules and invoking a graphics module in communication with the one or more software modules. A screen display is then outputted as determined by the one or more software modules and as provided by the graphics module. In another aspect of the present invention, a gaming device is described as having a processor, a monitor, and one or more middleware modules. The gaming device also includes one or more graphics modules wherein a graphics module provides a screen display for display on the monitor according to instructions provided by the one or more middleware modules.

In another aspect of the present invention, a method of increasing use of a gaming device is described. A user is enabled to obtain a service or good at a discount when using the gaming device. The service or good is obtained through operations performed by the user on the gaming device and wherein the discount is related to the amount of use of the gaming device by the user. In another aspect of the present invention, a method of increasing use of a gaming device by providing a user of the gaming device with entertainment content is described. The entertainment content is selected by the user while playing a game and the user can request the entertainment content without having to leave the gaming device.

In another aspect of the present invention a graphical user interface on a gaming device is described. The user interface contains a first region for displaying a first content relating to a game, a second region for displaying a second content relating to one or more non-game related services, and a third region for displaying a third content relating to a non-game related service wherein the third content is determined by a selection made from the second content displayed in the second region. In yet another aspect of the present invention a graphical user interface on a gaming device is described. The interface has a gaming region containing game content, a service menu region containing one or more symbols representing one or more services, and a service region containing service content corresponding to the one or more services.

### BRIEF DESCRIPTION OF THE DRAWINGS

FIG. 1 is a block diagram showing generally components of the gaming system or device in accordance with preferred embodiments of the present invention.

FIG. 2A is a block diagram displaying modules in the middleware component of the gaming device of the present invention.

FIG. 2B is a block diagram showing in greater detail game engine 206 in accordance with the preferred embodiments of the present invention.

FIGS. 3A and 3B are flow diagrams of a process of initially invoking the middleware software component in accordance with one embodiment of the present invention.

FIG. 4 is a flow diagram showing the process in which Flash content is retrieved and displayed on the monitor in accordance with the preferred embodiments of the present invention.

FIG. 5A is a screen shot showing the gaming functions and non-gaming functions shown on the monitor of the gaming device of the present invention.

FIG. 5B is a segment of a screenshot showing a menu bar containing six icons representing non-gaming functions of the present invention.

FIGS. 6A is a sample screen shot showing a sample drink ordering service offered through the gaming device of the present invention.

FIG. 6B is a sample screen shot showing a hotel room reservation service offered through the gaming device of the present invention.

FIG. 6C is a sample screen shot showing a ticket ordering service offered through the gaming device of the present invention.

FIG. 6D is a sample screen shot showing a restaurant menu/reservation service offered through the gaming device of the present invention.

FIG. 7 is a sample screen shot showing a gaming screen offered in the present invention.

FIG. 8 is a screen shot diagram showing region 508 of FIG. 5 and the display of information in areas normally concealed by an object in the present invention.

### DETAILED DESCRIPTION OF THE PREFERRED EMBODIMENTS

Reference will now be made in detail to a preferred embodiment of the invention. Examples of the preferred embodiments are illustrated in the accompanying drawings. While the invention will be described in conjunction with the preferred embodiments, it will be understood that they are not intended to limit the invention to one preferred embodiment. To the contrary, it is intended to cover alternatives, modifications, and equivalents as may be included within the spirit and scope of the invention as defined by the appended claims.

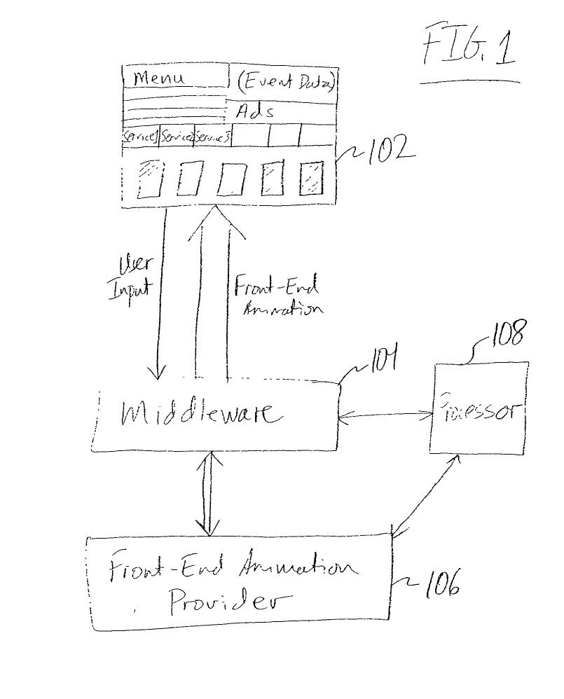

FIG. 1 is a block diagram showing generally components of the gaming system or device in accordance with one embodiment of the present invention. There are four primary components: a screen display 102 for displaying text and graphics to a user; a software component 104, referred to as middleware, for carrying out the instructions and logic for the gaming and non-gaming services; a front-end animation provider 106 for supplying the front-end screen shots and animation to software component 104 which causes it to be displayed on monitor 102. Monitor 102, software component 104, and animation provider 106 all function using processor 108. Processor 108 can be implemented in a various ways, such as with a typical personal computer in the gaming device or with a server providing processing for numerous other machines.

Software component 104 provides the instructions and logic for the gaming device. As such, it performs as middleware in that it provides instructions to animation provider 106 which sends graphics to screen display 102 via a graphics card. Animation provider 106 is instructed as to what needs to be displayed on screen display 102, retrieves the animation which is then displayed on screen display 102. In the preferred embodiments, middleware 104 and front-end animation provider 106 communicate using standard Windows sockets. Other types of communication devices can be used to communicate between these two components depending on what type of front-end animation provider is used and the platform on which middleware 104 is running. Animation provider 106 preferably does not generally perform logic or execute programming instructions relating to the gaming functions. In one of the preferred embodiments, the gaming and non-gaming functions are executed by software component 104, made up of numerous software modules described below. None of the front-end graphics and animation is programmed in software component 104 or hardcoded anywhere in its instructions. In the preferred embodiments, front-end animation provider 106 is implemented in Flash by Macromedia, Inc. of San Francisco, Calif. Numerous screen shots displayed to the user are described below.

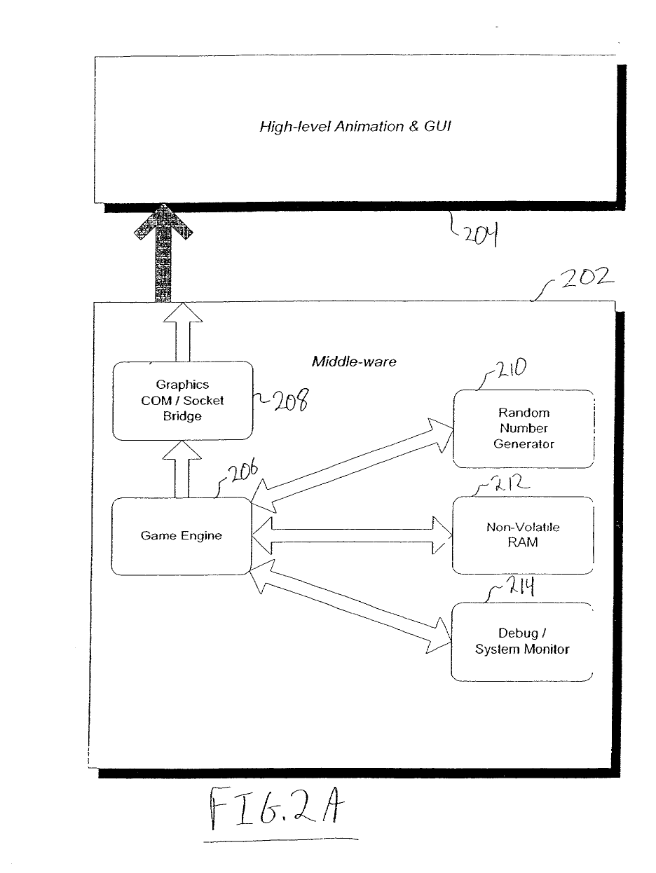

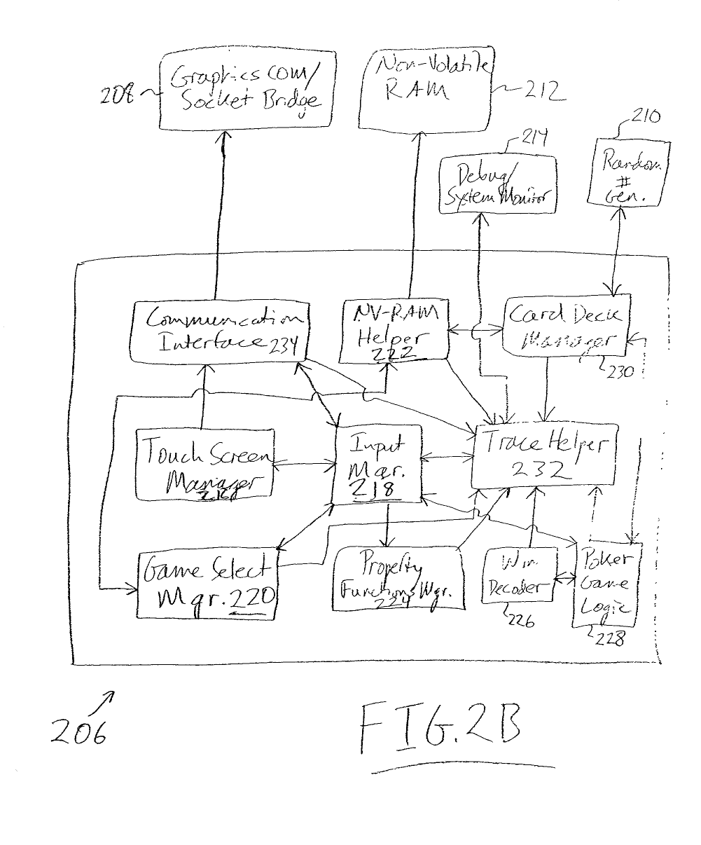

FIG. 2A is a block diagram displaying modules in the middleware component of the gaming device of the present invention. Middleware component 202 communicates with an animation and graphical user interface or front-end component 204. Middleware component 202 contains a game engine 206 which sends instructions or data to front-end component 204 via a graphics COM/Socket Bridge module 208. Game engine 206 is comprised of numerous modules and is described in greater detail in FIG. 2B. The use of graphics COM (Component Object Model)/Socket Bridge 208, a Microsoft-derived standard. In the preferred embodiment, it sends XML documents to the graphics front-end. Game engine 206 transmits and receives data from three modules: a standard random number generator 210, a non-volatile RAM, and a debug/system monitor 214 which outputs debug and monitor messages to an output device.

FIG. 2B is a block diagram showing in greater detail game engine 206 in accordance with the preferred embodiments of the present invention. An input manager module 218 accepts input from a touch-screen monitor in the preferred embodiments. Other forms of input can be used such as a conventional keyboard, a mouse, or audio input from a user. A touch screen manager 216 receives the raw (X,Y) coordinates of the from the point on the screen touched by the user. It sends this data to an input manager 218 which accepts the raw (X,Y) coordinates and then dispatches instructions to one of the appropriate managers described below.

A game selection manager 220 loads a game engine based on the game choice made by the user and the denomination (e.g., $1, $5, etc.) chosen by the user and can receive input from the input manager 218. Game select manager 220 can also accept input from a non-volatile RAM helper 222. Module 222 provides “helper” functions for access to non-volatile RAM 212. A property functions manager 224 handles processing when the user inputs or touches one of the non-gaming function regions or icons. Once module 224 receives input from input manager 218, it dispatches these instructions to the appropriate property functions manager.

Other modules include a win decoder 226 that determines and calculates win or loss amounts. Decoder 226 communicates with a game logic module 228, such as the poker game logic module shown. Game logic module 228 is in communication with a card deck manager 230 which is responsible for shuffling and validating the cards. As is commonly done in the computer programming practice, a trace helper module 232 is used to provider helper functions for the debug/system monitor module 214. Module 214 outputs debugging and monitoring messages to an output device such as a printer or a monitor. A communication interface module 234 outputs data intended for front-end graphics module 204 to graphicsCOM/socket bridge 208.

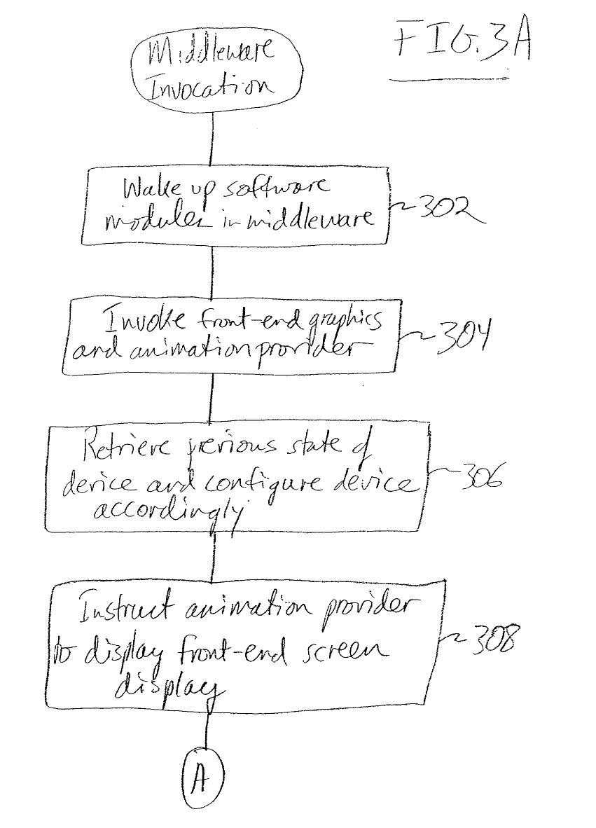

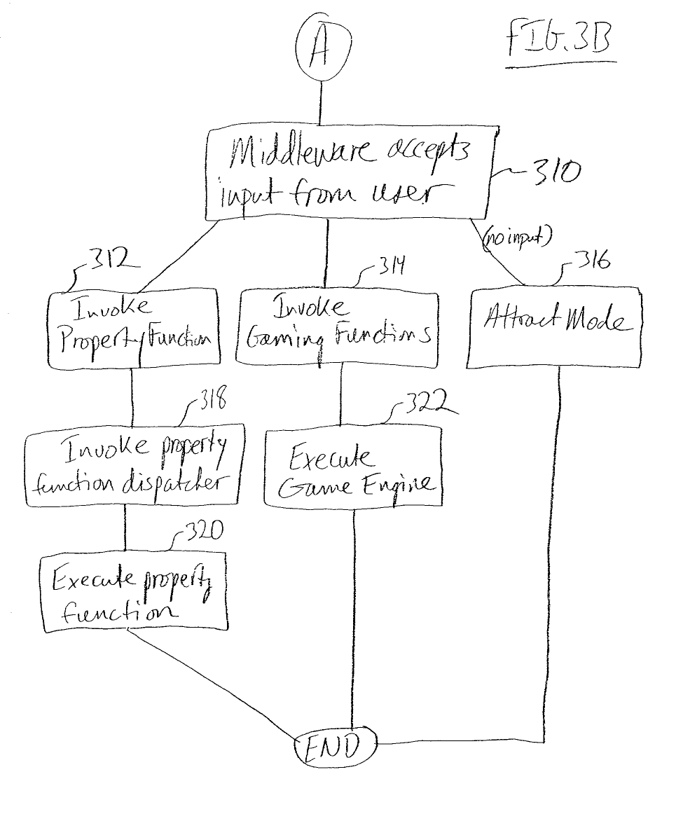

FIGS. 3A and 3B are flow diagrams of a process of initially invoking the middleware software component in accordance with one embodiment of the present invention. This process occurs after the gaming device has been powered on and the operating system has been loaded. At step 302 the software modules described in FIG. 2 are invoked or woken up, as is known in the field of computer programming. At step 304 software component or middleware launches the front-end animation and graphics provider, such as Flash. This can be done at the same time as step 302. In the preferred embodiments, the middleware invokes and directs what Flash content is shown on the screen display. In addition, it instructs the operating system to launch Flash when the gaming device is to be used. At step 306 the previous state of the gaming device before it was powered down or disabled in some manner is retrieved. Typically, the previous state of the machine is retrieved from non-volatile memory and used to configure the machine to its present state. This data is then loaded into the middleware and used to configure the gaming device. This state can be idle or the beginning of a new game or a game that was previously in progress. The gaming device is then configured based on the previous state. In most cases, the state will be idle and initial screen shots will be shown.

At step 308 the middleware instructs the front-end animation provider 108 to display the appropriate screen display to the user based on the present state of the gaming device. The animation provider then causes the display of the screen display or animation on the monitor for the user to see. In the preferred embodiments, the middleware is not involved in displaying the screen shots once they have been retrieved or created by the animation provider. As is known in the field, the images are sent via a video card directly to the monitor.

Once the new screen shot or animation is displayed, at step 310 of FIG. 3B, the middleware accepts input from the user. In the preferred embodiments, the input is received via a touch screen on the monitor instead of a physical keyboard. User input from the touch screen is detected using methods known in the field of computer programming. In other preferred embodiments, other methods of accepting input can be used such as a keyboard, pointer device, and audio input, and so on. Once the middleware receives the input at step 310, the gaming device can either service one of numerous property functions shown at step 312 or can begin the gaming functions at step 314. A third option is taken if there is no input from the screen display, most commonly when the user is done using the gaming device. At step 316 the animation provider supplies attract mode screen shots or property function screen shots with associated audio segments to the display and speakers advertising the game and non-gaming services and attempting to attract users to the gaming device. At this stage the middleware has been invoked and has entered normal operation mode or attract mode from which a user can initiate gaming or one of the property functions.

If the user chooses a particular property function, described in greater detail below, a property function dispatcher is invoked at step 318. The dispatcher ensures that the appropriate set of computer instructions and peripherals are instructed to carry out the property at step 320. For example, if the user chooses a “Room Reservation” function from the gaming device, a server on the hotel's private network is contacted with the request directly from the gaming device and the user is instructed to provide further information for making the reservation. In this example, a direct link between the gaming device and the hotel's private network is established using the appropriate protocol used by the network in the hotel.

If the user chooses to play the game, the game engine module of the middleware is executed at step 322. The logic in the game engine depends on the type of game being played. For example, for five-card stud poker, logic for playing the game is well-known in the gaming technology industry and is used to take the user through the game. As mentioned above, the middleware, whether executing a gaming function or a property function, instructs the front-end animation provider to display the appropriate screen shot to the user. Thus, the game engine and middleware in general does not contain computer instructions for generating graphics on the screen. There are no hard-coded images or series of screen shots that the middleware presents to the user. However, the middleware does contain all the logic and programming instructions to perform or invoke all the offered services and gaming options. Conversely, the front-end animation and graphics provider, such as Macromedia Flash 5, does not contain logic or intelligence as to the execution of the gaming functions or any of the property functions. It simply receives an XML stream from the middleware which contains instructions on what animation or screen shot should be displayed. This can vary from showing an entire movie, for example in attract mode to attract a user to use the device to changing one text field on the screen, such as the number of user credits. Macromedia Flash is described in greater detail below. In other preferred embodiments the same degree of modularity can be achieved using other types animation and graphics tools can be used to generate the front-end component of the gaming device.

As mentioned, in the preferred embodiments, front-end animation content is developed using Flash 5, a computer animation tool developed by Macromedia. Flash is an animation software tool for designing, developing and delivering low-bandwidth animations, screen shots and Web sites. It has scripting capabilities using a Flash feature called ActiveScript and has server-side connectivity for creating applications, Web interfaces, stand-alone device interfaces, training courses, and so on. Flash has been commercially available for several years and numerous books are available on its use and instruction. Macromedia, the maker of the Flash product, is located in San Francisco, Calif. and more information on Flash can be seen at www.macromedia.com.

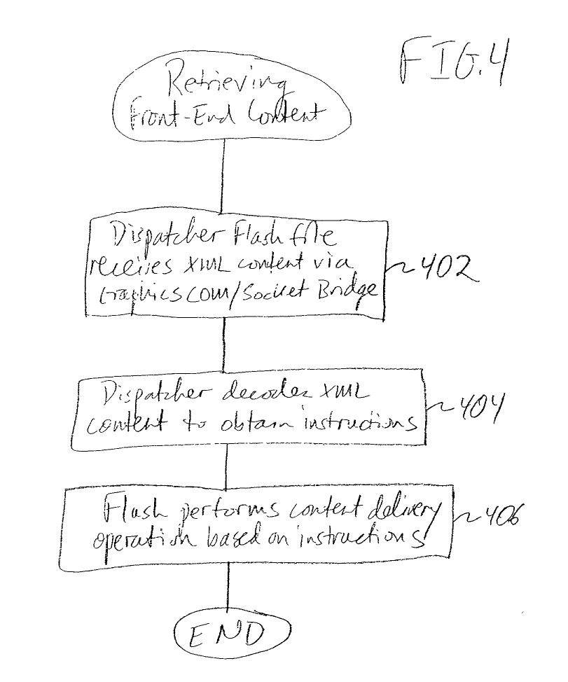

In the preferred embodiments, Flash content is retrieved upon a trigger by the game engine module in the middleware. FIG. 4 is a flow diagram showing the process in which Flash content is retrieved and displayed on the monitor in accordance with the preferred embodiments of the present invention. At step 402 the dispatcher Flash file receives the instructions from the middleware. In the preferred embodiments, the instructions are send in XML format. At step 404 the Flash module decodes the XML to obtain the instructions to update (or possibly not modify) the screen. Flash files can be organized in numerous ways. The most efficient organization will depend on how the Flash files are being used. In the preferred embodiments of the present invention, there is an individual Flash file for each property function. A Flash file can contain various types of contents, most commonly either a Flash movie or animation made up of a series of frames or a frame, such as a static screen shot. Flash also offers other media types not relevant to the present invention. In the preferred embodiments, there is one Flash file for the game function, one file for the Help function, and one for the Pay table.

At step 406 the Flash module performs one of four operations. As the functionality of the gaming device grows or more property functions and gaming options are added, the number of operations can increase. One operation is loading a submovie contained in a Flash file. This is done by an ActionScript( ), an authored or customized routine in Flash to carry out instructions. Another option is to update a dynamic text field in a Flash file, such as a screen shot. Within Flash there are dynamic text fields which can be provided a value and the text field will be dynamically updated. Another option is to play a movie or animation or go directly to a specific frame in the movie. For example, there can be a movie for each of the five cards in a hand when playing poker. Each movie can have 52 or more frames, one for each card and possibly wild cards. In order to go directly to a specific card, an identifier associated with that frame is used to retrieve the card and display it. In another option Flash moves positions of screen elements or changes their characteristics, such as graying out or making an element visible or invisible. As mentioned above, other animation tools such as Director by Marcromedia or HTML can be used to provide the front end animation and graphics tools.

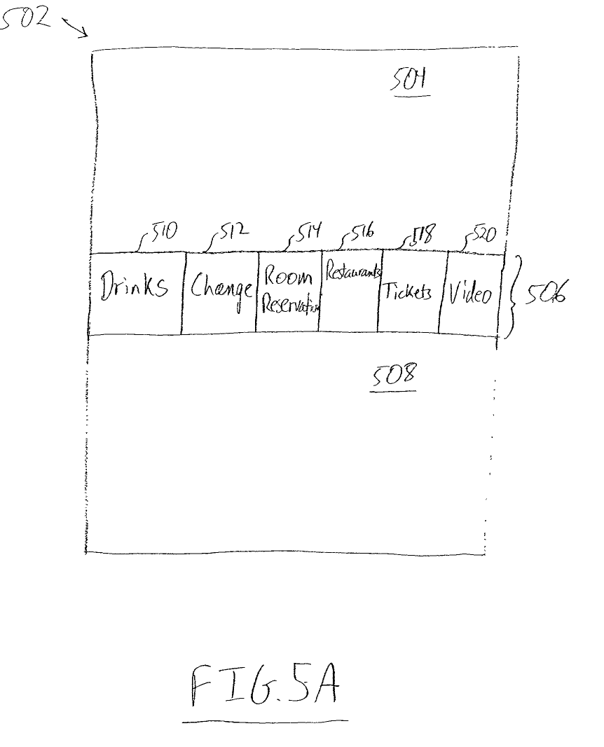

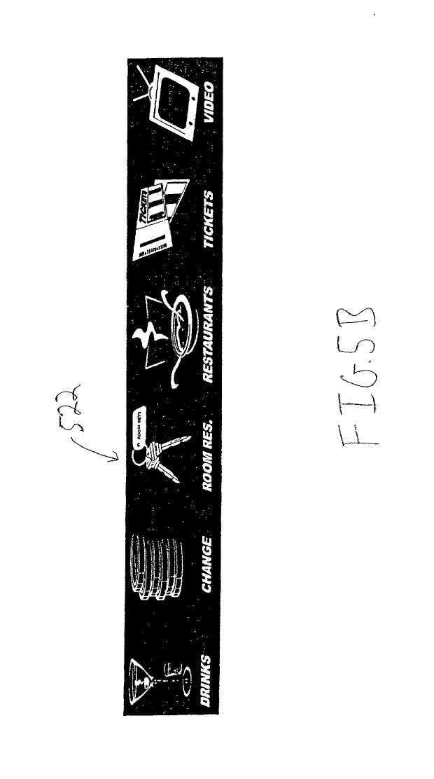

FIG. 5A is a screen shot showing the gaming functions and non-gaming functions shown on the monitor of the gaming device of the present invention. A screen display 502 has three primary areas or regions to accommodate the gaming functions and the non-gaming or associated equipment. Generally, the term associated equipment is used in the gaming industry to describe functions that do not involve a user inputting money for gaming purposes. They have been referred to in the present invention as non-gaming functionality. The three regions are region 504 on the top, region 506 in the center, and region 508 at the bottom. Region 506 is a menu window that contains icons representing the various property or non-gaming functions. In the preferred embodiments, these property function icons include Drinks 510, Change 512, Room Reservations 514, Restaurants 516, Tickets 518, and Video 520. FIG. 5B is a segment of a screen shot representing region 506. A menu bar 522 contains six icons representing various samples of non-gaming functions. In other embodiments icons for different property functions may be shown. When a particular function is chosen, screen shots and movies for that function are displayed in region 504.

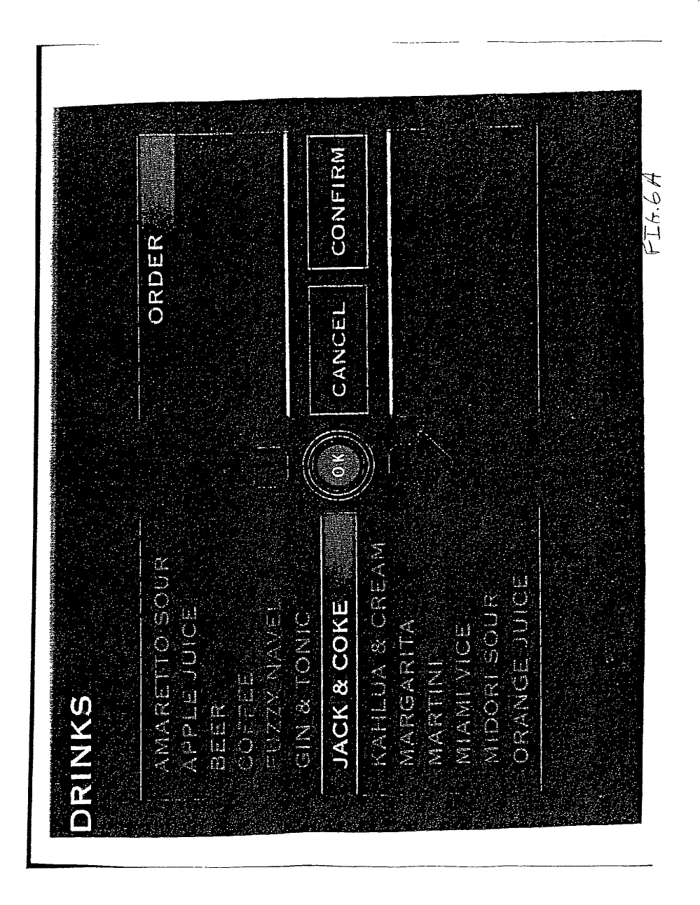

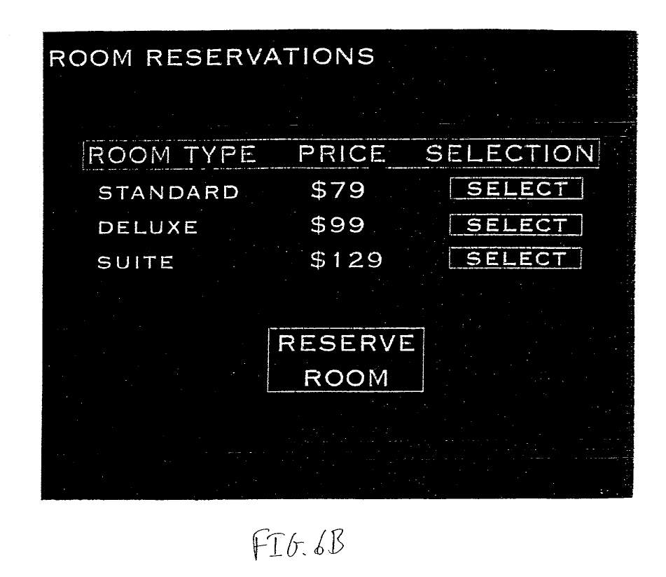

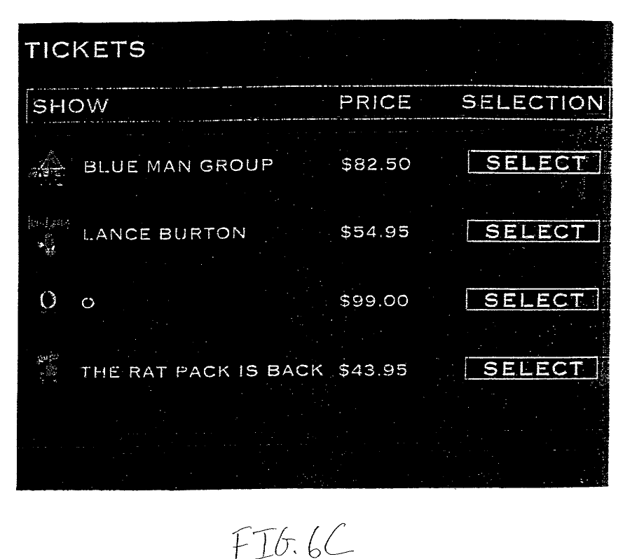

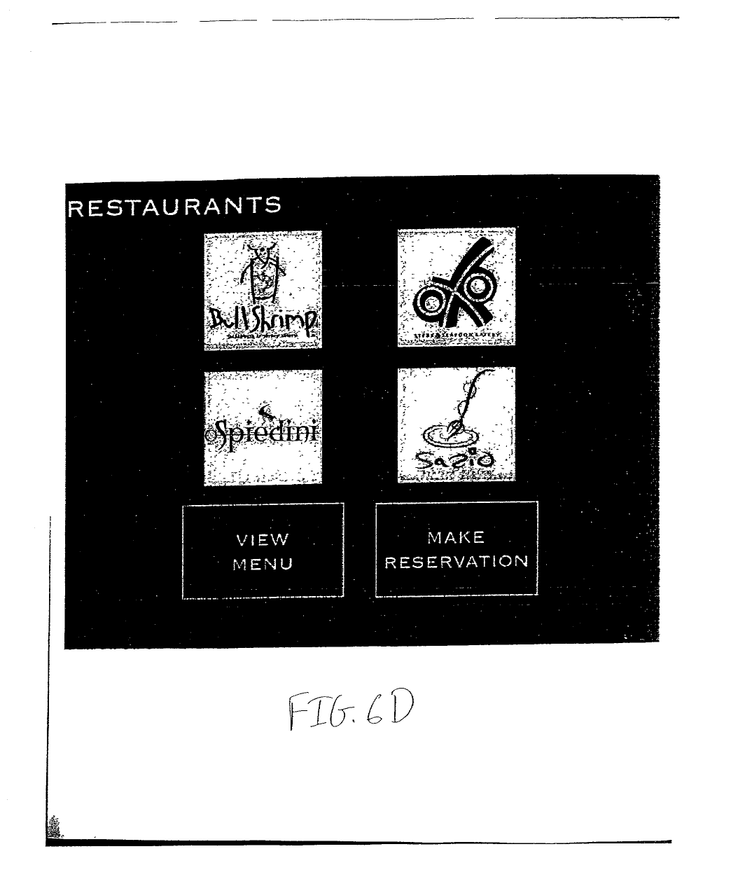

Examples of content displayed in region 504 when the Drinks icon 510 is selected is shown in FIG. 6A which shows a menu of drinks on the left-hand side, an “OK” or select button in the center, and an Order region on the right which allows the user to CANCEL or CONFIRM the order. FIG. 6B is a screen shot of a sample Hotel Room Reservation screen which displays a Room Type, Price, Selection button, and a Reserve Room button. Through this menu a user of a gaming device in a hotel casino, for example, can make reservations for a room in the hotel. FIG. 6C is a screen shot of a Ticket Ordering service offered in the gaming device of the present invention. Displayed are a list of Shows, Prices, and Select buttons through which a user can purchase tickets to the events listed. FIG. 6D is a screen shot showing various restaurant logos and a View Menu button and a Make Reservation button. The user can use this service to as desired without leaving the gaming device, as is true for all the non-gaming services described above.

When the user selects a property function, the middleware invokes the appropriate software and establishes contact with the necessary peripherals. First, as described above, the animation provider, such as Flash, is instructed to display the Drinks screen shot in region 504. Once displayed or at the same time, a connection is established with the computer system of the associated bar, if a connection is not already established. The drink order data is then input by the user and the data is transmitted to the computer ordering system for the bar using conventional and known methods of data transfer over a computer network. In another example, if the user selects Video icon 520 for example to view a line at a restaurant, a music video, sports and so on, a video line feed is used. For example, one coaxial cable with splitters for multiple channels can be used. Off-the-shelf components such as a TV/tuner card and splitters can be used to supply the video feeds to the gaming device. The sources of the video feeds is determined by the gaming device operator.

The other property functions involve establishing connections with either private or public networks. For example, Room Reservation icon 514 allows the user of the gaming device to connect to the hotel reservation system or to the front-desk. This service, along with the others such as Tickets, can be used by the gaming device operator to offer the user complimentary or discounted tickets depending on the extent of gaming by the user as recorded by that gaming device. Benefits to the user of the gaming device can come in various forms, most of which can relate directly to the non-gaming or property functions. For example, the gaming device operator can monitor whether the user is increasing the denomination of the bets and can reward the user by offering one or more of the non-gaming services. The benefit to the user can vary from faster service when ordering drinks or requesting change to free tickets to a sold-out event or a free room at the hotel for the night. Other options include discounted prices on any of the services, a table at fully booked restaurant, the option of watching a premium cable TV channel or a free movie at the gaming device. There are numerous incentives that the gaming device operator can offer the user. When these incentives are offered are also determined by the gaming device operator. For example, these incentives can be offered when the user accumulates a certain amount in losses or wins or after having played at a device for a certain length of time. The options are numerous and can be decided on by the gaming device operator. Similar incentives can be provided with any of the property functions. In this respect, the non-gaming functions are tied to the gaming functions but the two are maintained and operated separately. In addition, the user can use the gaming device with the goal of obtaining one of the services with some type of benefit as described above. For example, a user may know that she will spend up to $200 at a poker machine or spend at least one hour at the machine. If she knows that by spending that much time or money at a gaming device of the present invention she will receive some type of benefit with respect to one of the services, she will have more incentive to use that machine. It is also possible that a user's primary incentive is to get the particular benefit related to a service and will use the gaming device to obtain that benefit. That is, the user is not using the gaming device for entertainment value but rather to obtain the benefit, which may be available exclusively from the gaming device. In any of these scenarios, the use of the gaming device is likely to increase because of the newly added benefits of the present invention.

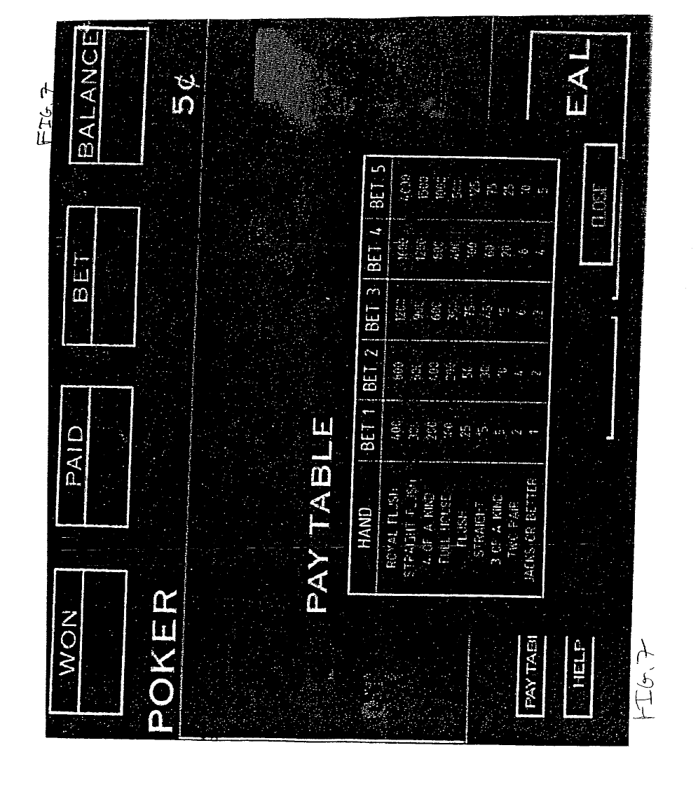

Region 508 in FIG. 5 displays gaming screens and animation. While such screen shots are widely know, an example is provided in FIG. 7 which is a screen shot showing a poker Pay Table. Naturally, other types of games can be displayed in region 508 as decided upon by the device operator. Regions 504, 506 and 508 can also be configured in various ways. For example, the gaming region 508 may occupy a greater portion of the screen while menu region 506 can be placed somewhere less conspicuous and region 504 may only appear if the user selects one of the icons in menu region 506. Conversely, the gaming device operator may want to emphasize the feature that the user can obtain services previously unavailable from a gaming device and make region 506 and 504 more prominent to attract the user. Irrespective of the configuration, the user interface offers the user the ability to select from one or more property functions or non-gaming functions or playing a game. By selecting one of the non-gaming functions, the user can perform activities that would normally require leaving the gaming device without having to do so. As mentioned, the user can play the game on the device and take advantage of special offers beyond complimentary drinks based on the dollar amount spent at the device.

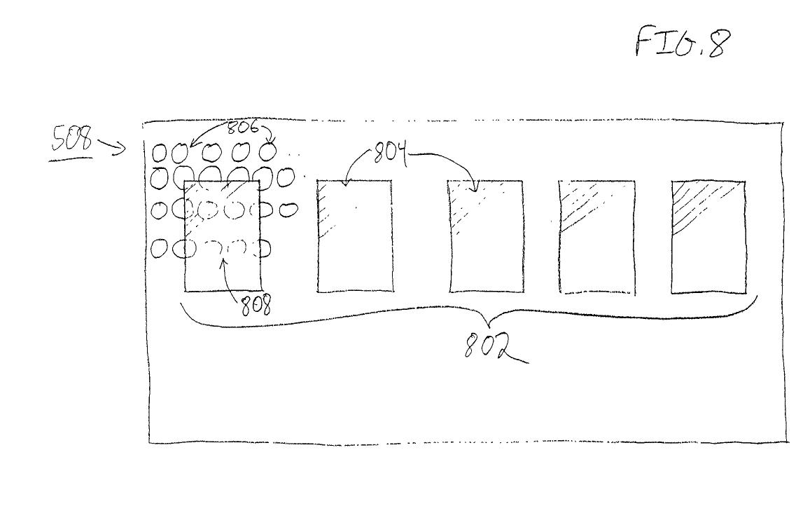

Game playing region 508 is also able to expand the way information is displayed to the user. Specifically, with card games information can be displayed behind the cards without revealing the identity of the card. FIG. 8 is a screen shot diagram showing region 508 of FIG. 5 and the display of information in areas normally concealed by an object in the present invention. Game playing region 508 is shown as having five cards 802 face down. The back of the cards are indicated by a pattern of parallel angled lines 804. So as to not reveal the identity of the cards, the pattern is the same for all the cards. Typically, the cards are opaque so that nothing behind the card can be seen. In the present invention, there is a background pattern of circles 806 on the screen. In the preferred embodiments, circles 808 covered by cards 802 are partially visible through the cards. This is done while not revealing the identity of the cards and allows the display of information in an area covered by cards 802 that would normally not be available for displaying information.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method of operating a gaming device comprising:
a gaming device invoking one or more software modules;
invoking a graphics module in communication with the one or more software modules; and
outputting a screen display as determined by the one or more software modules and as provided by the graphics module.

2. A gaming device comprising:
a processor;
a monitor;
one or more middleware modules;
one or more graphics modules wherein a graphics module provides a screen display for display on the monitor according to instructions provided by the one or more middleware modules.

3. A method of providing non-gaming functions on a gaming device comprising:
displaying a non-gaming service on a monitor of the gaming device;
accepting input from the monitor relating to the non-gaming service;
processing the input wherein a non-gaming engine in the gaming device is invoked; and
displaying a graphical user interface on the monitor provided by an animation generator separate from the non-gaming engine, wherein the animation generator receives instructions from the non-gaming engine.

4. A system for processing input on a gaming device comprising:
a processor;
a memory;
a first software component containing a game engine and a graphics interface; and
a second software component containing a plurality of graphic elements for use on the gaming device, wherein the first software component instructs the second software component on displaying one or more graphic elements on the gaming device.

5. A system as recited in claim 1 wherein the second software component does not execute instructions relating to game logic.

6. A system as recited in claim 1 wherein the first software component does not contain graphic elements for display on the gaming device.

7. A method of increasing use of a gaming device enabling a user of the gaming device to obtain a service or good with a benefit, wherein the service or good is obtained through operations performed by the user on the gaming device and wherein the benefit is related to use of the gaming device by the user.

8. A method as recited in claim 7 wherein the benefit is a discount given to the user related to the service or good.

9. A method as recited in claim 7 wherein the use of the gaming device includes a change in denomination by the user, length of time the user is using the gaming device, and an amount of a loss or win by the user on the gaming device.

10. A method as recited in claim 7 wherein the service or good is one of hotel reservations, tickets, and beverages.

11. A method of increasing use of a gaming device by providing a user of the gaming device with entertainment content selected by the user while playing a game and wherein the user can request the entertainment content without having to leave the gaming device.

12. A method as recited in claim 11 wherein the entertainment content is one of television content, movies, music, and music videos.

13. A method of increasing use of a gaming device by providing a user of the gaming device with audio/visual content of specific interest to the user while the user is playing a game and wherein the user can request the content without having to leave the gaming device.

14. A method as recited in claim 13 wherein the content of specific interest is one of restaurant wait time information, day care video feed, and online content chosen by the user.

15. A graphical user interface on a gaming device comprising:
a first region for displaying a first content relating to a game;
a second region for displaying a second content relating to one or more non-game related services; and
a third region for displaying a third content relating to a non-game related service wherein the third content is determined by a selection made from the second content displayed in the second region.

16. A graphical user interface as recited in claim 15 wherein the second region contains a plurality of subregions; a subregion containing a fourth content representing a non-game function.

17. A graphical user interface as recited in claim 16 wherein the fourth content representing a non-game function is a symbol representing one of making a hotel reservation, viewing a video feed, viewing entertainment content, purchasing tickets, requesting change, and ordering a beverage.

18. A graphical user interface as recited in claim 15 wherein the first region contains one or more subregions, a subregion capable of simultaneously displaying a fifth content and a sixth content.

19. A graphical user interface as recited in claim 18 wherein one of the fifth content or the sixth content is displayed in an altered manner.

20. A graphical user interface on a gaming device comprising:
a gaming region containing game content;
a service menu region containing one or more symbols representing one or more services; and
a service region containing service content corresponding to the one or more services.

21. A graphical user interface as recited in claim 20 wherein the one or more services include beverage ordering, change, hotel room reservations, show tickets, restaurant table information, video feeds from public and private cameras, video feeds from television, cable and satellite, music videos, and music.

22. A method of offering a service comprising:
receiving a first input from a user on a gaming device;
processing the input on a processor associated with the gaming device; and
offering the service to the user according to whether the input entitles the user to the service.

23. A method as recited in claim 22 wherein the service is selected from the group consisting of beverages, hotel reservations, tickets, video, television, and music.

24. A method as recited in claim 22 wherein offering the service further includes offering a benefit to the user related to the service.

25. A method of obtaining a service comprising:
utilizing a gaming device offering a non-gaming service; and
providing a particular amount of input to the gaming device such that the non-gaming service is obtained.

26. A method as recited in claim 25 wherein the non-gaming service is selected from the group consisting of hotel room reservations, tickets, video, television, music, and drinks.

27. A method as recited in claim 25 wherein a benefit relating to the non-gaming service is obtained.
